(19) United States
(12) Patent Application Publication
(10) Pub. No.: US 2023/0253595 A1
(43) Pub. Date: Aug. 10, 2023

(54) MICROTEXTURED PROTON EXCHANGE MEMBRANE FOR FUEL CELL AND PROCESSING METHOD THEREOF

(71) Applicant: Jiangsu University, Jiangsu (CN)

(72) Inventors: Xuan XIE, Jiangsu (CN); Bifeng YIN, Jiangsu (CN); Fei DONG, Jiangsu (CN); Hekun JIA, Jiangsu (CN); Sheng XU, Jiangsu (CN); Xin CHEN, Jiangsu (CN)

(73) Assignee: Jiangsu University, Jiangsu (CN)

(21) Appl. No.: 18/012,658

(22) PCT Filed: Feb. 4, 2021
(86) PCT No.: PCT/CN2021/075283

§ 371 Date: Dec. 23, 2022

(30) Foreign Application Priority Data
Jul. 29, 2020 (CN) 202010743936.9
Jul. 29, 2020 (CN) 202010745281.9

(51) Int. Cl. H01M 8/1065; H01M 8/1039; H01M 8/1086

(52) U.S. Cl. CPC H01M 8/1065; H01M 8/1039; H01M 8/1093; H01M 2008/1095

(57) ABSTRACT

The present invention provides a microtextured proton exchange membrane for a fuel cell and a processing method thereof. A plurality of concave-convex composite textures are distributed in a gradient pattern of being dense inside and sparse outside on a cathode surface of the proton exchange membrane for the fuel cell. The plurality of concave-convex composite textures are petal-shaped and each include a pit and a protrusion. The protrusion is arranged along an edge of the pit, and a plurality of hemi-ellipsoidal micro-pits are uniformly distributed on an inner surface of the pit. The cathode surface is divided into a central region, an intermediate region, and a peripheral region according to distances between the adjacent concave-convex composite textures, and in each of the regions, the distances between the adjacent concave-convex composite textures are gradually increased from inside to outside in a gradient pattern.

### TECHNICAL FIELD

The present disclosure relates to the field of fuel cells, and in particular, to a microtextured proton exchange membrane for a fuel cell and a processing method thereof.

### DESCRIPTION OF RELATED ART

With the worsening of environmental pollution, fuel cells have been highlighted both at home and abroad because of their high conversion efficiency and pollution-free characteristics. The proton exchange membrane fuel cell (PEMFC) is a widely used fuel cell, and is considered the most promising green energy conversion device to replace the conventional fossil fuels due to its advantages such as high energy conversion efficiency, high operating reliability, environmental friendliness, few moving parts, and no noise.

The membrane electrode assembly is a core structural component of the proton exchange membrane fuel cell, and the proton exchange membrane is one of the core components that constitute the membrane electrode assembly. The proton exchange membrane has the functions of conducting protons, isolating the hydrogen and oxygen gas, and preventing the gases from mixing and reacting between the cathode flow channel and the anode flow channel. Meanwhile, the two surfaces of the proton exchange membrane are also the places where the catalytic reaction occurs and are in direct contact with the catalyst. Therefore, the proton exchange membrane must have the characteristics of high chemical stability, high proton conductivity, good compactness, high mechanical strength, and the like.

The proton exchange membrane is located between the cathode and the anode catalyst layer and is in direct contact with the catalyst. Its surface micromorphology structure has great impacts on catalyst utilization, electrical conductivity, proton conduction, and the like. With the in-depth study of the proton exchange membrane, the patterned membrane has become a current research hotspot. The patterned membrane can largely increase the surface area of the proton exchange membrane, and can greatly improve the catalyst utilization and accelerate the reaction when the specific pattern size matches with the catalyst size. The patterned membrane also has the advantages of improving the proton conductivity and electrical conductivity, reducing the impedance, making the membrane thinner, and the like. The use of a patterned proton exchange membrane can greatly improve the performance of the membrane from all aspects.

Meanwhile, water is continuously produced at the cathode side of the proton exchange membrane as the cell runs. If the water cannot be discharged in time, flooding will occur, and the water will cover the membrane surface to block the reaction, thereby reducing the reaction efficiency of the cell. When the water is insufficient, the proton conductivity will decrease, causing performance degradation of the cell. Therefore, the proton exchange membrane also needs to have the characteristic of optimized water management.

Currently, the precious metal platinum is basically used as the active component of the catalyst in the proton exchange membrane fuel cell, and the price of platinum is very high, which seriously affects the research process of the proton exchange membrane fuel cell. Therefore, the improvement of the utilization of the platinum catalyst and the study of the proton exchange membrane with ultra-low platinum loading are of great significance in the development of the proton exchange membrane. The improvement of catalyst utilization can not only reduce the platinum loading to lower the cost of the proton exchange membrane, but also increase the efficiency of the catalytic reaction, thereby improving the performance of the cell.

With the research on the patterned proton exchange membrane, many researchers have changed the microstructure of the membrane surface to obtain a proton exchange membrane with advantages such as ultra-low platinum loading, high catalyst utilization, high proton conductivity, large triple phase boundary, and low cost. A Chinese patent discloses that a layer of a polymer electrolyte is sprayed on both sides of a proton exchange membrane to change the microstructure of the boundary between an electrolyte membrane and an electrode. During the electrode preparation process, the key components of the electrode are aligned in the same direction by using a negative pressure, an external electric field, and other means, thereby enlarging the triple phase boundary and improving the catalyst utilization. A Chinese patent discloses that a carbon support (XC-72) is activated in a CO₂ atmosphere before use, and the specific steps include: (1) placing the carbon support (XC-72) in a flowing CO₂ atmosphere and heating to 350-900° C. for activation of 1-12 hours; (2) loading Pt by means of precipitation on the carbon support activated by the above step to obtain a Pt/C catalyst. The electrode catalyst made by the Pt/C catalyst of this patent and used for the proton exchange membrane fuel cell has high electrocatalytic activity. The above 10 patents help to enlarge the triple phase boundary and improve the catalyst utilization, but the operation is too complicated and takes a long time, which is not conducive to large-scale commercial production.

### SUMMARY

To eliminate the defects in the prior art, the present disclosure provides a microtextured proton exchange membrane for a fuel cell and a processing method thereof, wherein concave-convex composite textures are designed on a cathode surface of the proton exchange membrane, and a patterned membrane with the concave-convex composite textures is formed. It can not only increase the surface area of the cathode surface of the proton exchange membrane, but also make carbon groups embedded in larger pit structures and platinum groups embedded in the carbon groups and placed in smaller micro-pits, so that the carbon-supported platinum catalyst is stably attached to the membrane surface and the active area of the catalyst is increased, thereby improving the catalyst utilization. Meanwhile, the concave-convex composite textures are distributed in a gradient pattern of being dense inside and sparse outside on the membrane surface, so that the reaction can be carried out more sufficiently and efficiently. In addition, the concave-convex composite textures can also optimize water management. The manufacturing process of the present disclosure is simple and is suitable for commercial production.

The present disclosure achieves the above objective through the following technical solutions.

A microtextured proton exchange membrane for a fuel cell, characterized in that a plurality of concave-convex composite textures are distributed in a gradient pattern of being dense inside and sparse outside on a cathode surface of the proton exchange membrane for the fuel cell.

Further, the plurality of concave-convex composite textures are petal-shaped and each include a pit and a protrusion, the protrusion is arranged along an edge of the pit, and a plurality of hemi-ellipsoidal micro-pits are uniformly distributed on an inner surface of the pit.

Further, the plurality of concave-convex composite textures are annularly distributed on the cathode surface; the cathode surface is divided into a central region a, an intermediate region b, and a peripheral region c according to distances between the adjacent concave-convex composite textures, and in each of the regions, the distances between the adjacent concave-convex composite textures are gradually increased from inside to outside in a gradient pattern; the distance between every two of the adjacent concave-convex composite textures in the central region a is S₁=50-250 μm; the distance between every two of the adjacent concave-convex composite textures in the intermediate region b is S₂=250-450 μm; and the distance between every two of the adjacent concave-convex composite textures in the peripheral region c is S₃=450-600 μm.

Further, a radius of the pit is R=20-200 μm and a depth of the pit is H=20-200 μm; a radius of the protrusion is r=5-120 μm and a height of the protrusion is h₁=5-120 μm; and the plurality of concave-convex composite textures account for 35%-65% of a total area of the cathode surface.

Further, the plurality of concave-convex composite textures are rectangularly distributed on the cathode surface; the cathode surface is divided into a central region a, an intermediate region b, and a peripheral region c according to distances between the adjacent concave-convex composite textures, and in each of the regions, the distances between the adjacent concave-convex composite textures are gradually increased from inside to outside in a gradient pattern; the distance between every two of the adjacent concave-convex composite textures in the central region a is S₁=50-200 μm; the distance between every two of the adjacent concave-convex composite textures in the intermediate region b is S₂=200-400 μm; and the distance between every two of the adjacent concave-convex composite textures in the peripheral region c is S₃=400-600 μm.

Further, a radius of the pit is R=20-200 μm and a depth of the pit is H=20-200 μm; a radius of the protrusion is r=5-100 μm and a height of the protrusion is h₁=5-100 μm; and the plurality of concave-convex composite textures account for 30%-60% of a total area of the cathode surface.

Further, the inner surface of the pit is divided into a plurality of parallel layers, and a plurality of hemi-ellipsoidal micro-pits are uniformly distributed along a circumference of a parallel layer of the parallel layers; angles formed between centers of circles of the hemi-ellipsoidal micro-pits on the adjacent parallel layers and a center of a circle of the pit are 16-24°; a major axis length of the hemi-ellipsoidal micro-pit is 2-12 μm, a minor axis length of the hemi-ellipsoidal micro-pit is 1-10 μm, a depth of the hemi-ellipsoidal micro-pit is h₂=1-10 μm, and a distance between every two of the adjacent hemi-ellipsoidal micro-pits on the layers is 1-12 μm.

Further, the concave-convex composite texture includes a first protrusion, a second micro-protrusion, and a micro-pit, wherein the second micro-protrusion is arranged along an edge of the first protrusion, and a cross-sectional area of the first protrusion is greater than that of the second micro-protrusion; the micro-pit is arranged between the first protrusion and the second micro-protrusion, and a side wall of the micro-pit is both tangential to a side wall of the first protrusion and to a side wall of the second micro-protrusion.

Further, the first protrusion is a hemispheroidal protrusion, the second micro-protrusion is an annular protrusion with a semicircular cross section, and the micro-pit is an annular pit with a semicircular cross section.

Further, the plurality of concave-convex composite textures are rectangularly distributed on the cathode surface; the cathode surface is divided into a central region a, an intermediate region b, and a peripheral region c according to distances between the adjacent concave-convex composite textures, and in each of the regions, the distances between the adjacent concave-convex composite textures are gradually increased from inside to outside in a gradient pattern; the distance between every two of the adjacent concave-convex composite textures in the central region a is S₁=50-250 μm; the distance between every two of the adjacent concave-convex composite textures in the intermediate region b is S₂=250-450 μm; and the distance between every two of the adjacent concave-convex composite textures in the peripheral region c is S₃=450-600 μm.

Further, a radius of the first protrusion is r₁=10-280 μm and a height of the first protrusion is h₃=10-280 μm; a radius of the micro-pit is r₂=5-140 μm and a depth of the micro-pit is h₄=5-140 μm; a radius of the second micro-protrusion is r₃=5-140 μm and a height of the second micro-protrusion is h₅=5-140 μm; and the concave-convex composite textures account for 40%-70% of a total surface area of the cathode surface.

Further, the plurality of concave-convex composite textures are annularly distributed on the cathode surface; the cathode surface is divided into a central region a, an intermediate region b, and a peripheral region c according to distances between the adjacent concave-convex composite textures, and in each of the regions, the distances between the adjacent concave-convex composite textures are gradually increased from inside to outside in a gradient pattern; the distance between every two of the adjacent concave-convex composite textures in the central region a is S₁=50-280 μm; the distance between every two of the adjacent concave-convex composite textures in the intermediate region b is S₂=280-480 μm; and the distance between every two of the adjacent concave-convex composite textures in the peripheral region c is S₃=480-600 μm.

Further, a radius of the first protrusion is r₁=10-300 μm and a height of the first protrusion is h₃=10-300 μm; a radius of the micro-pit is r₂=5-160 μm and a depth of the micro-pit is h₄=5-160 μm; a radius of the second micro-protrusion is r₃=5-160 μm and a height of the second micro-protrusion is h₅=5-160 μm; and the concave-convex composite textures account for 35%-70% of a total surface area of the cathode surface.

A processing method of the microtextured proton exchange membrane for the fuel cell includes the following steps:

processing the cathode surface directly by laser, so that the cathode surface is partially gasified and a plurality of petal-shaped concave-convex composite textures are formed;

deburring by ultrasonic cleaning or glow discharge cleaning or sputter cleaning.

Further, specific parameters of the laser processing include divergence angle being smaller than 0.5 mrad, output beam quality being M≤1.3, spot diameter being not greater than 3 mm, wavelength being 1064 nm, power being 1-25 W, single pulse energy being 1-100 μJ, pulse width being 1-100 ps, and repetition frequency being 1-10 MHz.

A processing method of the microtextured proton exchange membrane for the fuel cell includes the following steps:

obtaining a first stamping die with the pits and the protrusions by plasma etching or ultrafast laser processing, and deburring the first stamping die by ultrasonic cleaning and glow discharge cleaning;

processing the pits and the protrusions on the cathode surface by using the first stamping die;

obtaining a second stamping die with the hemi-ellipsoidal micro-pits by plasma etching or ultrafast laser processing, and deburring the second stamping die by ultrasonic cleaning and glow discharge cleaning;

processing the hemi-ellipsoidal micro-pits on the cathode surface by using the second stamping die.

The present disclosure has the following beneficial effects:

1. According to the microtextured proton exchange membrane for the fuel cell of the present disclosure, the petal-shaped concave-convex composite textures are provided on the cathode surface of the proton exchange membrane, which can greatly enlarge the triple phase boundary and improve the catalyst utilization and reaction efficiency.

2. According to the microtextured proton exchange membrane for the fuel cell of the present disclosure, the carbon-supported platinum catalyst can be embedded in the petal-shaped concave-convex composite textures, the catalytic active area can be effectively increased, and the catalyst utilization is improved.

3. According to the microtextured proton exchange membrane for the fuel cell of the present disclosure, the petal-shaped concave-convex composite textures are divided into three regions at different intervals, and the distances between the adjacent concave-convex composite textures in each region are in a gradient pattern of being dense inside and sparse outside, which conforms to the gradient distribution characteristic of the catalyst and can make the catalytic reaction more sufficient and efficient.

4. According to the microtextured proton exchange membrane for the fuel cell of the present disclosure, the petal-shaped concave-convex composite textures can store water to some extent, and when the dynamic balance of water changes, these structures can achieve a certain compensation effect, thereby improving the water management.

5. According to the microtextured proton exchange membrane for the fuel cell of the present disclosure, the performance of the proton exchange membrane can be partially improved by merely changing its micromorphology, and the membrane can be made thinner and lighter.

6. According to the microtextured proton exchange membrane for the fuel cell of the present disclosure, the existence of the first protrusions and the second micro-protrusions can effectively prevent irregular movement of catalytic particles, and the coupling of the protrusions and the pits can force the catalytic particles to be embedded at the bottom of these structures, so that the catalytic particles can be regulated and the catalytic active area is effectively enlarged, which is beneficial to improve the catalyst utilization, raise the efficiency of the electrocatalytic reaction, and improve the performance of the fuel cell.

7. According to the microtextured proton exchange membrane for the fuel cell of the present disclosure, the interior of the micro-pit structure is a closed surface, which can function as a micro-reservoir and thus optimize the water management.

8. According to the microtextured proton exchange membrane for the fuel cell of the present invention, the performance of the proton exchange membrane can be partially improved by merely changing its micromorphology, and the membrane can be made thinner and lighter.

9. The processing method of the microtextured proton exchange membrane for the fuel cell of the present disclosure is simple and only needs to provide the petal-shaped concave-convex composite textures on the cathode surface of the proton exchange membrane, which greatly enlarges the triple phase boundary. The method is easy to implement and is suitable for large-scale commercial production.

### BRIEF DESCRIPTION OF THE DRAWINGS

FIG. 1 is a three-dimensional view of Example 1 of a microtextured proton exchange membrane for a fuel cell according to the present disclosure.

FIG. 2 is a top view of Example 1.

FIG. 3 shows division of three regions at different intervals in Example 1.

FIG. 4 is a three-dimensional view of Example 2 of the microtextured proton exchange membrane for the fuel cell according to the present disclosure.

FIG. 5 is a top view of Example 2.

FIG. 6 shows division of three regions at different intervals in Example 2.

FIG. 7 is a sectional view of concave-convex composite textures.

FIG. 8 is a schematic enlarged view of \textcircled{1} in FIG. 7.

FIG. 9 is a comparison diagram of polarization curves between the prior art and Example 1 and Example 2 of the present disclosure.

FIG. 10 is a three-dimensional view of Example 3 of the microtextured proton exchange membrane for the fuel cell according to the present disclosure.

FIG. 11 is a top view of Example 3 according to the present disclosure.

FIG. 12 is a three-dimensional view of Example 4 of the microtextured proton exchange membrane for the fuel cell according to the present disclosure.

FIG. 13 is a top view of Example 4 according to the present disclosure.

FIG. 14 is a schematic enlarged view of the concave-convex composite texture at I.

FIG. 15 is a cross-sectional view of the concave-convex composite textures.

FIG. 16 is a partial enlarged view of FIG. 15.

FIG. 17 is a comparison diagram of polarization curves between a flat sheet membrane in the prior art and Example 3 and Example 4 of the present disclosure.

FIG. 18 is a comparison diagram of the current density at a voltage of 0.4 V on the flat sheet membrane in the prior art and on a cathode surface of the proton exchange membrane in Example 1 and Example 3 of the present disclosure.

FIG. 19 is a comparison diagram of the mass fraction of water at a voltage of 0.7 V on the flat sheet membrane in the prior art and on the cathode surface of the proton exchange membrane in Example 1 and Example 3 of the present disclosure.

FIG. 20 is a comparison diagram of the mass fraction of O₂ at a voltage of 0.7 V on the flat sheet membrane in the prior art and on the cathode surface of the proton exchange membrane in Example 1 and Example 3 of the present disclosure.

In the drawings

1. proton exchange membrane; 2. cathode surface; 3. concave-convex composite texture; 4. pit; 5. protrusion; 6. hemi-ellipsoidal micro-pit; 7. first protrusion; 8. micro-pit; 9. second micro-protrusion; a. central region; b. intermediate region; c. peripheral region.

### DESCRIPTION OF THE EMBODIMENTS

The present disclosure is further described below with reference to the accompanying drawings and specific examples, but the protection scope of the present disclosure is not limited thereto.

Examples of the present disclosure are described in detail below and are exemplified in the accompanying drawings, wherein the same or similar reference signs indicate the same or similar elements or elements with the same or similar functions. The examples described below with reference to the accompanying drawings are exemplary and are intended to explain the present disclosure, instead of limiting the present disclosure.

In the description of the present disclosure, it should be understood that terms such as “central”, “longitudinal”, “transverse”, “length”, “width”, “thickness”, “upper”, “lower”, “axial”, “radial”, “vertical”, “horizontal”, “inner”, and “outer” indicate directional or positional relationships based on the accompanying drawings. They are merely used for the convenience and simplicity of the description of the present disclosure, instead of indicating or implying that the demonstrated device or element is located in a specific direction or is constructed and operated in a specific direction. Therefore, they cannot be construed as limitations to the present disclosure. Moreover, terms “first” and “second” are merely used for the purpose of description, and cannot be understood as indicating or implying relative importance or implicitly indicating the number of denoted technical features. Therefore, a feature defined by “first” or “second” explicitly or implicitly includes one or more such features. In the description of the present disclosure, “a plurality of” means two or more, unless otherwise expressly defined.

In the present disclosure, unless otherwise expressly specified and defined, terms such as “mounted”, “interconnected”, “connected”, and “fixed” should be understood in a broad sense.

For example, they may be fixed connections, detachable connections, or integral connections; may be mechanical connections or electrical connections; may be direct connections or indirect connections through an intermediate medium; and may be internal communications between two elements. The specific meanings of the above terms in the present disclosure can be understood by persons of ordinary skill in the art according to specific situations.

### EXAMPLE 1

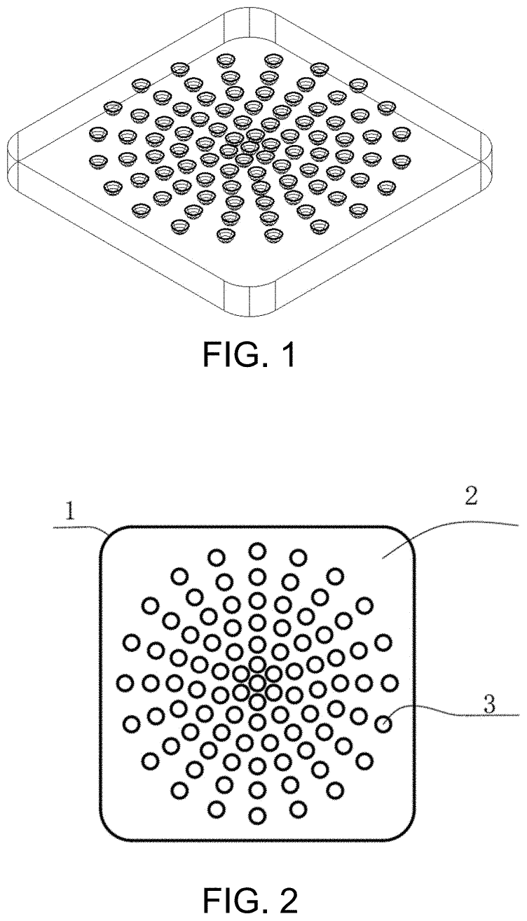

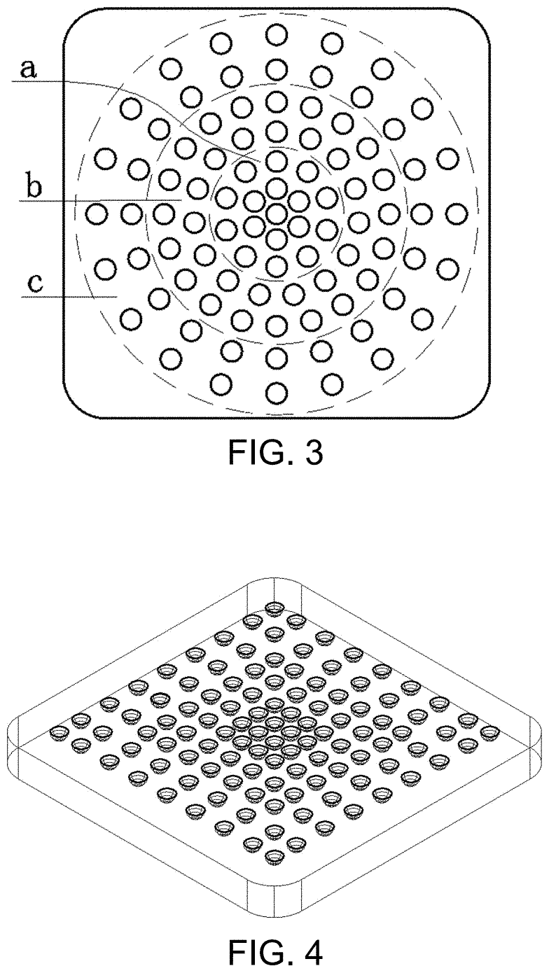

As shown in FIG. 1, FIG. 2, and FIG. 3, according to the microtextured proton exchange membrane for the fuel cell of the present disclosure, the proton exchange membrane 1 is a perfluorinated sulfonic acid proton exchange membrane and has a length of 50 mm, a width of 50 mm, and a thickness of 150 μm. A plurality of petal-shaped concave-convex composite textures 3 are distributed in a gradient pattern of being dense inside and sparse outside on a cathode surface 2 of the proton exchange membrane. The concave-convex composite texture 3 includes a pit 4 and a protrusion 5, the protrusion 5 is arranged along an edge of the pit 4, and a plurality of hemi-ellipsoidal micro-pits 6 are uniformly distributed on an inner surface of the pit 4. The pit 4 may be a hemispherical pit and may also be a circular hole wherein the bottom of the circular hole is a hemispherical surface tangential to a cylindrical surface of the circular hole. The protrusion 5 may be a hemispherical protrusion and may also be a cylinder wherein the top of the cylinder is a hemispheroid tangential to the cylindrical surface. The plurality of concave-convex composite textures 3 are annularly distributed on the cathode surface 2. The cathode surface 2 is divided into a central region a, an intermediate region b, and a peripheral region c according to distances between the adjacent concave-convex composite textures 3, and in each of the regions, the distances between the adjacent concave-convex composite textures 3 are gradually increased from inside to outside in a gradient pattern, which is shown in FIG. 2. The concave-convex composite textures 3 can greatly enlarge the triple phase boundary, increase the active area of the carbon-supported platinum catalyst, effectively improve the catalyst utilization, and store water to some extent. When the dynamic balance of water changes, these structures can achieve a certain compensation effect, thereby optimizing the water management.

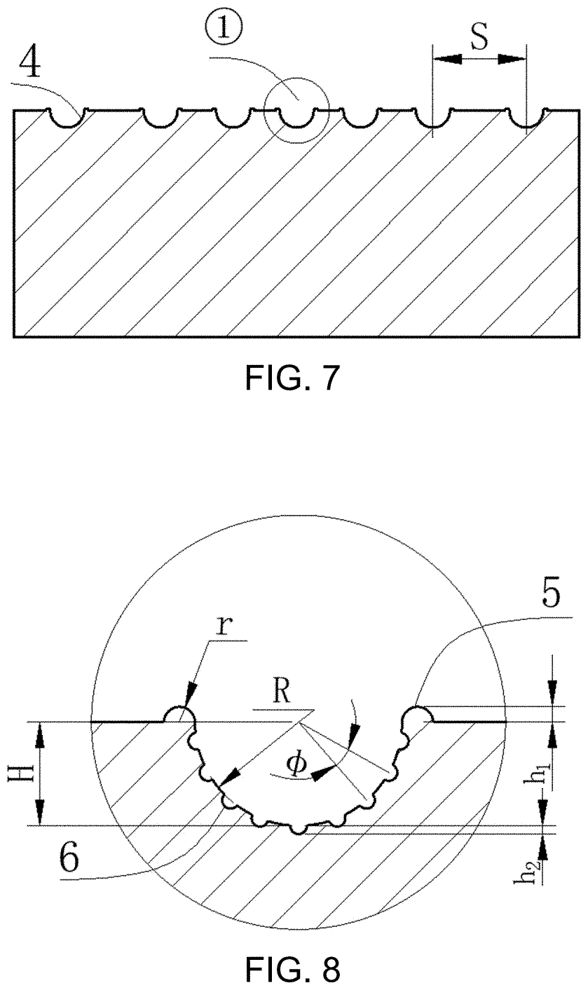

As shown in FIG. 7 and FIG. 8, the distance between every two of the adjacent concave-convex composite textures 3 in the central region a is S₁=80-250 μm; the distance between every two of the adjacent concave-convex composite textures 3 in the intermediate region b is S₂=250-400 μm; and the distance between every two of the adjacent concave-convex composite textures 3 in the peripheral region c is S₃=450-550 μm. A radius of the pit 4 is R=100 μm and a depth of the pit 4 is H=100 μm; a radius of the protrusion 5 is r=40 μm and a height of the protrusion 5 is h₁=40 μm; and the plurality of concave-convex composite textures 3 account for 58.2% of a total area of the cathode surface 2. The inner surface of the pit 4 is divided into five parallel layers, and a plurality of hemi-ellipsoidal micro-pits 6 are uniformly distributed along a circumference of any one of the parallel layers; angles formed between centers of circles of the hemi-ellipsoidal micro-pits 6 on the adjacent parallel layers and a center of a circle of the pit 4 are 20°; a major axis length of the hemi-ellipsoidal micro-pit 6 is 8 μm, a minor axis length of the hemi-ellipsoidal micro-pit 6 is 6 μm, a depth of the hemi-ellipsoidal micro-pit 6 is h₂=6 μm, and a distance between every two of the adjacent hemi-ellipsoidal micro-pits 6 on the layers is 6 μm.

A processing method of the microtextured proton exchange membrane for the fuel cell in Example 1 is a direct laser processing method. The cathode surface 2 is processed directly by laser, so that the cathode surface 2 is partially gasified and a plurality of petal-shaped concave-convex composite textures 3 are formed. Specific parameters of the laser processing include divergence angle being smaller than 0.5 mrad, output beam quality being M=1, spot diameter being not greater than 3 mm, wavelength being 1064 nm, power being 15 W, single pulse energy being 80 μJ, pulse width being 80 ps, and repetition frequency being 10 MHz. After the laser processing, deburring is performed by ultrasonic cleaning, glow discharge cleaning, and sputter cleaning to obtain the microtextured proton exchange membrane for the fuel cell.

### EXAMPLE 2

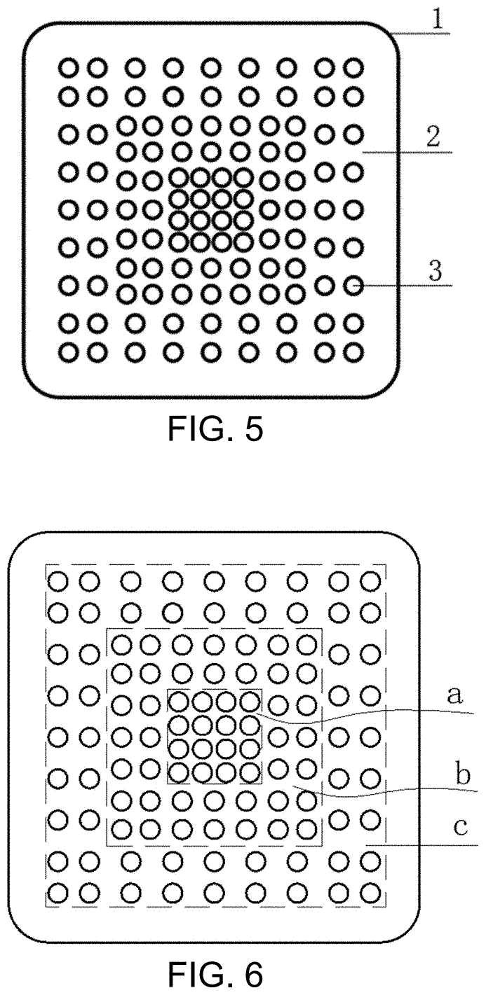

As shown in FIG. 4, FIG. 5, and FIG. 6, according to the microtextured proton exchange membrane for the fuel cell of the present disclosure, the proton exchange membrane 1 is a perfluorinated sulfonic acid proton exchange membrane and has a length of 50 mm, a width of 50 mm, and a thickness of 150 μm. A plurality of petal-shaped concave-convex composite textures 3 are distributed in a gradient pattern of being dense inside and sparse outside on a cathode surface 2 of the proton exchange membrane. The concave-convex composite texture 3 includes a pit 4 and a protrusion 5, the protrusion 5 is arranged along an edge of the pit 4, and a plurality of hemi-ellipsoidal micro-pits 6 are uniformly distributed on an inner surface of the pit 4. The pit 4 may be a hemispherical pit and may also be a circular hole wherein the bottom of the circular hole is a hemispherical surface tangential to a cylindrical surface of the circular hole. The plurality of concave-convex composite textures 3 are rectangularly distributed on the cathode surface 2. The cathode surface 2 is divided into a central region a, an intermediate region b, and a peripheral region c according to distances between the adjacent concave-convex composite textures 3, and in each of the regions, the distances between the adjacent concave-convex composite textures 3 are gradually increased from inside to outside in a gradient pattern. The distance between every two of the adjacent concave-convex composite textures 3 in the central region a is S₁=70-200 μm; the distance between every two of the adjacent concave-convex composite textures 3 in the intermediate region b is S₂=200-360 μm; and the distance between every two of the adjacent concave-convex composite textures 3 in the peripheral region c is S₃=400-560 μm. A radius of the pit 4 is R=120 μm and a depth of the pit 4 is H=120 μm; a radius of the protrusion 5 is r=50 μm and a height of the protrusion 5 is h₁=50 μm; and the plurality of concave-convex composite textures 3 account for 54% of a total area of the cathode surface 2. The inner surface of the pit 4 is divided into five parallel layers, and a plurality of hemi-ellipsoidal micro-pits 6 are uniformly distributed along a circumference of any one of the parallel layers; angles formed between centers of circles of the hemi-ellipsoidal micro-pits 6 on the adjacent parallel layers and a center of a circle of the pit 4 are 20°; a major axis length of the hemi-ellipsoidal micro-pit 6 is 8 μm, a minor axis length of the hemi-ellipsoidal micro-pit 6 is 6 μm, a depth of the hemi-ellipsoidal micro-pit 6 is h₂=6 μm, and a distance between every two of the adjacent hemi-ellipsoidal micro-pits 6 on the layers is 6 μm.

A processing method of the microtextured proton exchange membrane for the fuel cell in Example 2 includes the following steps.

A first stamping die with the pits 4 and the protrusions 5 is obtained by plasma etching or ultrafast laser processing, and the first stamping die is deburred by ultrasonic cleaning and glow discharge cleaning.

The pits 4 and the protrusions 5 on the cathode surface 2 are processed by using the first stamping die.

A second stamping die with the hemi-ellipsoidal micro-pits 6 is obtained by plasma etching or ultrafast laser processing, and the second stamping die is deburred by ultrasonic cleaning and glow discharge cleaning.

The hemi-ellipsoidal micro-pits 6 on the cathode surface 2 are processed by using the second stamping die.

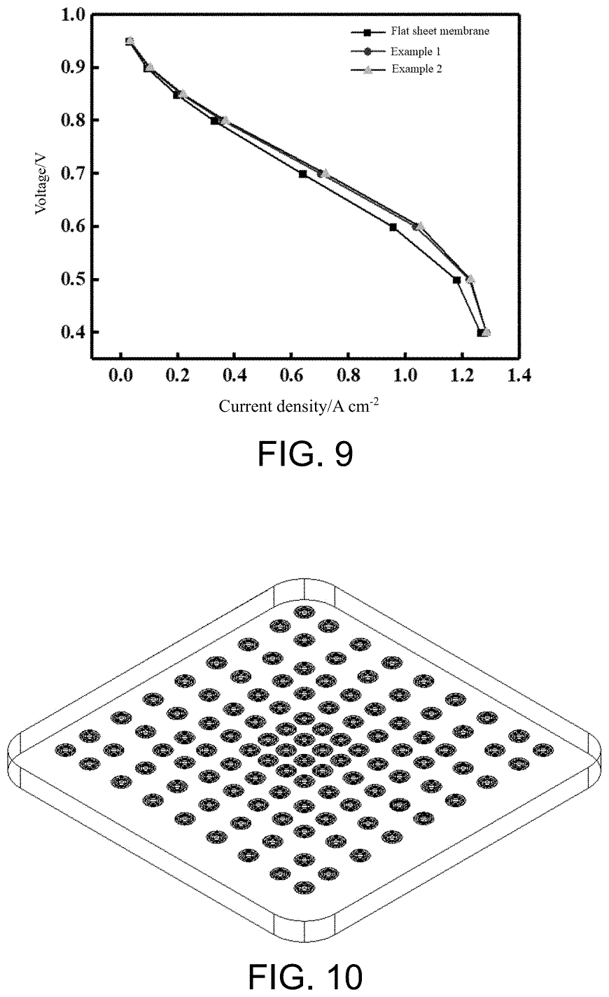

FIG. 9 is a comparison diagram of polarization curves between a flat sheet membrane in the prior art and Example 1 and Example 2 of the present disclosure in the same situation. It can be seen from FIG. 9 that, the current density acquired at the same voltage in Example 1 and Example 2 of the present disclosure is higher than that of the flat sheet membrane in the prior art, and the current density acquired in Example 2 is higher than that in Example 1. Therefore, the microtextured proton exchange membrane for the fuel cell of the present disclosure can indeed improve the performance of the fuel cell.

### EXAMPLE 3

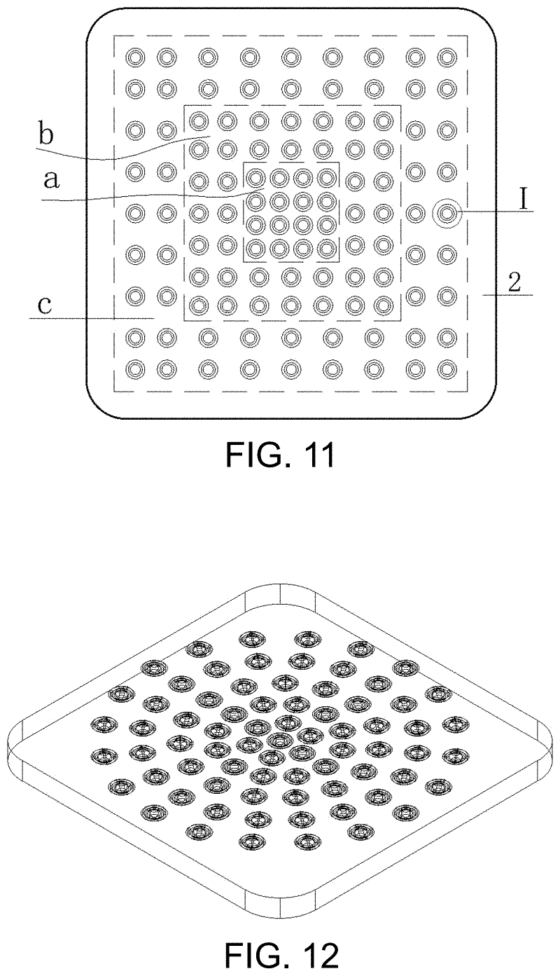

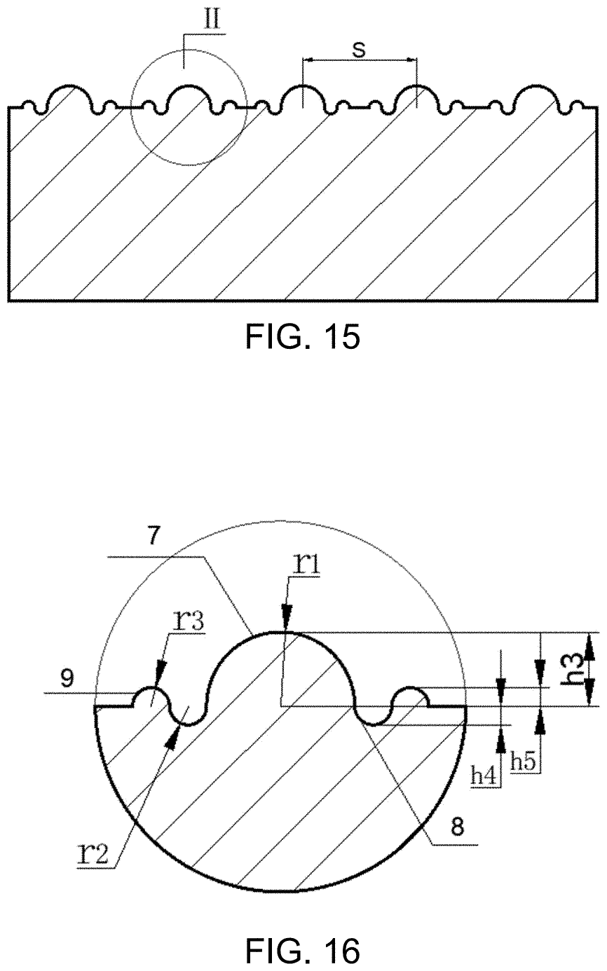

As shown in FIG. 10, FIG. 11, FIG. 15, and FIG. 16, according to the microtextured proton exchange membrane for the fuel cell of the present disclosure, the proton exchange membrane is a perfluorinated sulfonic acid proton exchange membrane and has a length of 60 mm, a width of 60 mm, and a thickness of 150 μm. A plurality of concave-convex composite textures 3 are distributed in a gradient pattern of being dense inside and sparse outside on a cathode surface 2 of the proton exchange membrane for the fuel cell. The concave-convex composite texture 3 includes a first protrusion 7, a second micro-protrusion 9, and a micro-pit 8, wherein the second micro-protrusion 9 is arranged along an edge of the first protrusion 7, and a cross-sectional area of the first protrusion 7 is greater than that of the second micro-protrusion 9; the micro-pit 8 is arranged between the first protrusion 7 and the second micro-protrusion 9, and a side wall of the micro-pit 8 is both tangential to a side wall of the first protrusion 7 and to a side wall of the second micro-protrusion 9. The first protrusion 7 is a hemispheroidal protrusion, the second micro-protrusion 9 is an annular protrusion with a semicircular cross section, and the micro-pit 8 is an annular pit with a semicircular cross section. The plurality of concave-convex composite textures 3 are rectangularly distributed on the cathode surface 2. The cathode surface 2 is divided into a central region a, an intermediate region b, and a peripheral region c according to distances between the adjacent concave-convex composite textures 3, and in each of the regions, the distances between the adjacent concave-convex composite textures 3 are gradually increased from inside to outside in a gradient pattern. The distance between every two of the adjacent concave-convex composite textures 3 in the central region a is S₁=60-250 μm; the distance between every two of the adjacent concave-convex composite textures 3 in the intermediate region b is S₂=280-420 μm; and the distance between every two of the adjacent concave-convex composite textures 3 in the peripheral region c is S₃=450-560 μm. As shown in FIG. 11, the concave-convex composite textures 3 can greatly increase the specific surface area of the membrane, the existence of the first protrusions 7 and the second micro-protrusions 9 can effectively prevent irregular movement of catalytic particles, and the coupling of the protrusions and the pits can force the catalytic particles to be embedded at the bottom of these structures, so that the catalytic particles can be regulated and the catalyst utilization is improved. Meanwhile, the bottom of the micro-pit 8 is a closed surface which can function as a micro-reservoir, thereby optimizing the water management.

A radius of the first protrusion 7 is r₁=100 μm and a height of the first protrusion 7 is h₃=100 μm; a radius of the micro-pit 8 is r₂=50 μm and a depth of the micro-pit 8 is h₄=50 μm; a radius of the second micro-protrusion 9 is r₃=50 μm and a height of the second micro-protrusion 9 is h₅=50 μm; and the concave-convex composite textures 3 account for 62% of a total surface area of the cathode surface 2.

A processing method of the proton exchange membrane for the fuel cell that has concave-convex composite micro-structures is compression molding, which specifically includes the following steps: Corresponding textures are formed on a mold by ion etching or ultrafast laser processing and the textures are mapped onto a membrane. Then, deburring is performed by ultrasonic cleaning, glow discharge cleaning, and sputter cleaning, to obtain the proton exchange membrane for the fuel cell that has the concave-convex composite micro-structures.

### EXAMPLE 4

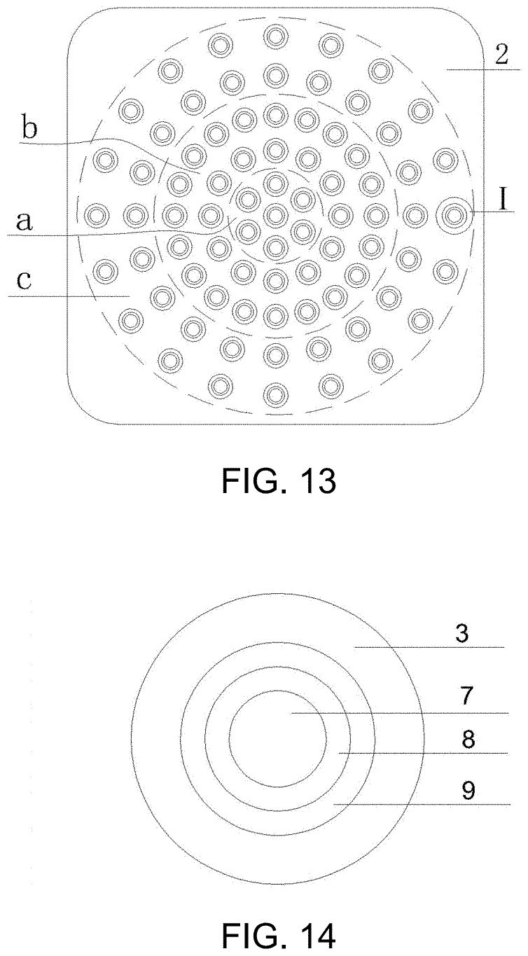

As shown in FIG. 12, FIG. 13, FIG. 15, and FIG. 16, according to the microtextured proton exchange membrane for the fuel cell of the present disclosure, the proton exchange membrane is a perfluorinated sulfonic acid proton exchange membrane and has a length of 60 mm, a width of 60 mm, and a thickness of 150 μm. A plurality of concave-convex composite textures 3 are distributed in a gradient pattern of being dense inside and sparse outside on a cathode surface 2 of the proton exchange membrane for the fuel cell. The concave-convex composite texture 3 includes a first protrusion 7, a second micro-protrusion 9, and a micro-pit 8, wherein the second micro-protrusion 9 is arranged along an edge of the first protrusion 7, and a cross-sectional area of the first protrusion 7 is greater than that of the second micro-protrusion 9; the micro-pit 8 is arranged between the first protrusion 7 and the second micro-protrusion 9, and a side wall of the micro-pit 8 is both tangential to a side wall of the first protrusion 7 and to a side wall of the second micro-protrusion 9. The first protrusion 7 is a hemispheroidal protrusion, the second micro-protrusion 9 is an annular protrusion with a semicircular cross section, and the micro-pit 8 is an annular pit with a semicircular cross section. The plurality of concave-convex composite textures 3 are annularly distributed on the cathode surface 2. The cathode surface 2 is divided into a central region a, an intermediate region b, and a peripheral region c according to distances between the adjacent concave-convex composite textures 3, and in each of the regions, the distances between the adjacent concave-convex composite textures 3 are gradually increased from inside to outside in a gradient pattern. The distance between every two of the adjacent concave-convex composite textures 3 in the central region a is S₁=60-280 μm; the distance between every two of the adjacent concave-convex composite textures 3 in the intermediate region b is S₂=300-480 μm; and the distance between every two of the adjacent concave-convex composite textures 3 in the peripheral region c is S₃=480-600 μm. As shown in FIG. 13, the concave-convex composite textures 3 can greatly increase the specific surface area of the membrane, the existence of the first protrusions 7 and the second micro-protrusions 9 can effectively prevent irregular movement of catalytic particles, and the coupling of the protrusions and the pits can force the catalytic particles to be embedded at the bottom of these structures, so that the catalytic particles can be regulated and the catalyst utilization is improved. Meanwhile, the bottom of the micro-pit 8 is a closed surface which can function as a micro-reservoir, thereby optimizing the water management.

A radius of the first protrusion 7 is r₁=120 μm and a height of the first protrusion 7 is h₃=120 μm; a radius of the micro-pit 8 is r₂=60 μm and a depth of the micro-pit 8 is h₄=60 μm; a radius of the second micro-protrusion 9 is r₃=60 μm and a height of the second micro-protrusion 9 is h₅=60 μm; and the concave-convex composite textures 3 account for 60% of a total surface area of the cathode surface 2.

A processing method of the microtextured proton exchange membrane for the fuel cell in Example 3 and Example 4 is compression molding, which specifically includes the following steps: Corresponding textures are formed on a mold by ion etching or ultrafast laser processing and the textures are mapped onto a membrane. Then, deburring is performed by ultrasonic cleaning, glow discharge cleaning, and sputter cleaning, to obtain the proton exchange membrane for the fuel cell that has the concave-convex composite micro-structures.

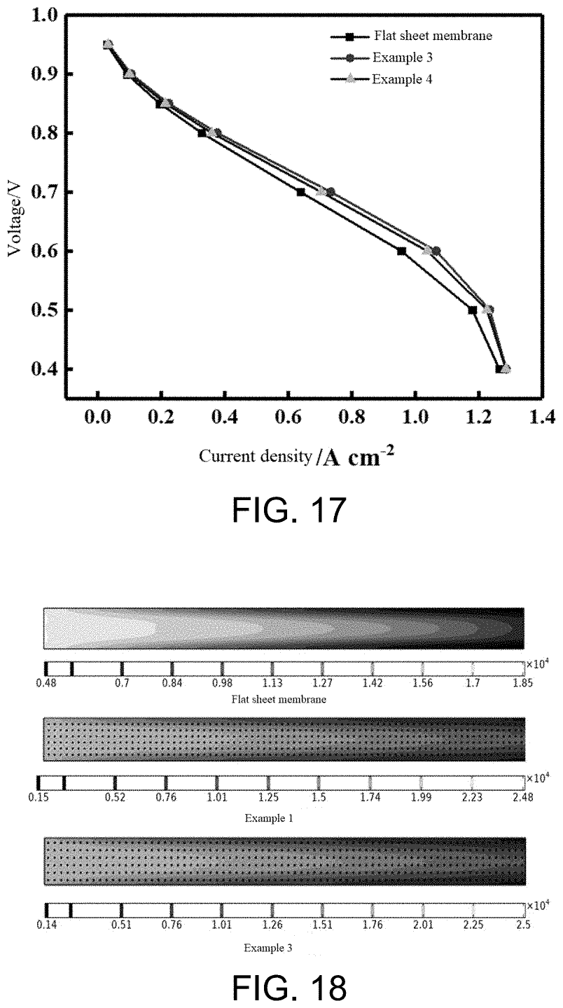

FIG. 17 is a comparison diagram of polarization curves between the flat sheet membrane in the prior art and Example 3 and Example 4 of the present disclosure in the same situation. It can be seen from FIG. 17 that, the current density acquired at the same voltage in Example 3 and Example 4 of the present disclosure is higher than that of the flat sheet membrane in the prior art, and the current density acquired in Example 3 is higher than that in Example 4, which indicates that the rectangularly distributed micro-pattern structures achieve a better effect. Therefore, the microtextured proton exchange membrane for the fuel cell of the present disclosure can indeed improve the performance of the fuel cell.

FIG. 18 is a comparison diagram of the current density at a voltage of 0.4 V on the flat sheet membrane in the prior art and on the cathode surface of the proton exchange membrane in Example 1 and Example 3 of the present disclosure. It can be seen from FIG. 18 that, the current density acquired at the same voltage in Example 1 and Example 3 of the present disclosure is higher than that of the flat sheet membrane in the prior art, and the current density acquired in Example 1 is similar to that in Example 3.

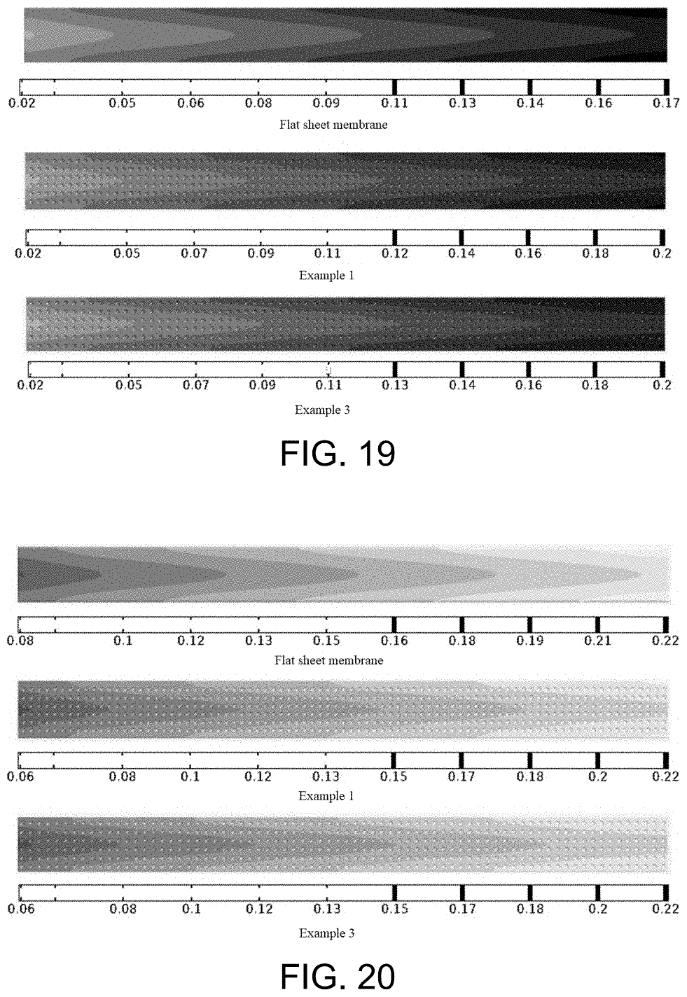

FIG. 19 is a comparison diagram of the mass fraction of water at a voltage of 0.7 V on the flat sheet membrane in the prior art and on the cathode surface of the proton exchange membrane in Example 1 and Example 3 of the present disclosure. It can be seen from FIG. 19 that, the mass fraction of water acquired at the same voltage on the cathode surface of the membrane in Example 1 and Example 3 of the present disclosure is greater than that of the flat sheet membrane in the prior art, which indicates that the pit structures in the micro-structure membrane of the present disclosure can indeed store water to some extent, thereby enhancing the wettability of the membrane.

FIG. 20 is a comparison diagram of the mass fraction of O₂ at a voltage of 0.7 V on the flat sheet membrane in the prior art and on the cathode surface of the proton exchange membrane in Example 1 and Example 3 of the present disclosure. It can be seen from FIG. 20 that, the mass fraction of O₂ acquired at the same voltage on the cathode surface of the membrane in Example 1 and Example 3 of the present disclosure is slightly lower than that of the flat sheet membrane, which indicates that the micro-structure membrane of the present disclosure can accelerate the oxygen consumption, thereby improving the reaction efficiency.

It should be understood that although this specification is described in accordance with the examples, each example does not merely include one independent technical solution. This narrative way of the specification is only for clarity, and persons skilled in the art should regard the specification as a whole. The technical solutions in the examples can also be appropriately combined to form other embodiments that can be understood by persons skilled in the art.

The above descriptions are merely practical examples of the present disclosure, and are not intended to limit the protection scope of the present disclosure. Any equivalent examples or modifications made without departing from the spirit of the present disclosure shall fall within the protection scope of the present disclosure.

1. (canceled)

2. A microtextured proton exchange membrane for a fuel cell, wherein a plurality of concave-convex composite textures are distributed in a gradient pattern of being dense inside and sparse outside on a cathode surface of the proton exchange membrane for the fuel cell, the plurality of concave-convex composite textures are petal-shaped and each concave-convex composite textures comprises a pit and a protrusion, the protrusion is arranged along an edge of the pit, and a plurality of hemi-ellipsoidal micro-pits are uniformly distributed on an inner surface of the pit.

3. The microtextured proton exchange membrane for the fuel cell according to claim 2, wherein the plurality of concave-convex composite textures are annularly distributed on the cathode surface; the cathode surface is divided into a central region, an intermediate region, and a peripheral according to distances between the adjacent concave-convex composite textures, and in each of the regions, the distances between the adjacent concave-convex composite textures are gradually increased from inside to outside in a gradient pattern; a distance between every two of the adjacent concave-convex composite textures in the central region is S₁=50-250 μm; a distance between every two of the adjacent concave-convex composite textures in the intermediate region is S₂=250-450 μm; and a distance between every two of the adjacent concave-convex composite textures in the peripheral region is S₃=450-600 μm.

4. The microtextured proton exchange membrane for the fuel cell according to claim 3, wherein a radius of the pit is R=20-200 μm and a depth of the pit is H=20-200 μm; a radius of the protrusion is r=5-120 μm and a height of the protrusion is h₁=5-120 μm; and
the plurality of concave-convex composite textures account for 35%-65% of a total area of the cathode surface.

5. The microtextured proton exchange membrane for the fuel cell according to claim 2, wherein the plurality of concave-convex composite textures are rectangularly distributed on the cathode surface; the cathode surface is divided into a central region, an intermediate region, and a peripheral region according to distances between the adjacent concave-convex composite textures, and in each of the regions, the distances between the adjacent concave-convex composite textures are gradually increased from inside to outside in a gradient pattern; a distance between every two of the adjacent concave-convex composite textures in the central region is S₁=50-200 μm; a distance between every two of the adjacent concave-convex composite textures in the intermediate region is S₂=200-400 μm; and a distance between every two of the adjacent concave-convex composite textures in the peripheral region is S₃=400-600 μm.

6. The microtextured proton exchange membrane for the fuel cell according to claim 5, wherein a radius of the pit is R=20-200 μm and a depth of the pit is H=20-200 μm; a radius of the protrusion is r=5-100 μm and a height of the protrusion is h₁=5-100 μm; and the plurality of concave-convex composite textures account for 30%-60% of a total area of the cathode surface.

7. The microtextured proton exchange membrane for the fuel cell according to claim 2, wherein the inner surface of the pit is divided into a plurality of parallel layers, and a plurality of hemi-ellipsoidal micro-pits are uniformly distributed along a circumference of a parallel layer of the parallel layers; angles formed between centers of circles of the hemi-ellipsoidal micro-pits on the adjacent parallel layers and a center of a circle of the pit are 16-24°; a major axis length of the hemi-ellipsoidal micro-pit is 2-12 μm, a minor axis length of the hemi-ellipsoidal micro-pit is 1-10 μm, a depth of the hemi-ellipsoidal micro-pit is h₂=1-10 μm, and a distance between every two of the adjacent hemi-ellipsoidal micro-pits on the layers is 1-12 μm.

8. The microtextured proton exchange membrane for the fuel cell according to claim 2, wherein the concave-convex composite texture comprises a first protrusion, a second micro-protrusion, and a micro-pit, wherein the second micro-protrusion is arranged along an edge of the first protrusion, and a cross-sectional area of the first protrusion is greater than a cross-sectional area of the second micro-protrusion; the micro-pit is arranged between the first protrusion and the second micro-protrusion, and a side wall of the micro-pit is both tangential to a side wall of the first protrusion and to a side wall of the second micro-protrusion.

9. The microtextured proton exchange membrane for the fuel cell according to claim 8, wherein the first protrusion is a hemispheroidal protrusion, the second micro-protrusion is an annular protrusion with a semicircular cross section, and the micro-pit is an annular pit with a semicircular cross section.

10. The microtextured proton exchange membrane for the fuel cell according to claim 9, wherein the plurality of concave-convex composite textures are rectangularly distributed on the cathode surface; the cathode surface is divided into a central region, an intermediate region, and a peripheral region according to distances between the adjacent concave-convex composite textures, and in each of the regions, the distances between the adjacent concave-convex composite textures are gradually increased from inside to outside in a gradient pattern; a distance between every two of the adjacent concave-convex composite textures in the central region is S₁=50-250 μm; a distance between every two of the adjacent concave-convex composite textures in the intermediate region is S₂=250-450 μm; and a distance between every two of the adjacent concave-convex composite textures in the peripheral region is S₃=450-600 μm.

11. The microtextured proton exchange membrane for the fuel cell according to claim 10, wherein a radius of the first protrusion is r₁=10-280 μm and a height of the first protrusion is h₃=10-280 μm; a radius of the micro-pit is r₂=5-140 μm and a depth of the micro-pit is h₄=5-140 μm; a radius of the second micro-protrusion is r₃=5-140 μm and a height of the second micro-protrusion is h₅=5-140 μm; and the concave-convex composite textures account for 40%-70% of a total surface area of the cathode surface.

12. The microtextured proton exchange membrane for the fuel cell according to claim 9, wherein the plurality of concave-convex composite textures are annularly distributed on the cathode surface; the cathode surface is divided into a central region, an intermediate region, and a peripheral region according to distances between the adjacent concave-convex composite textures, and in each of the regions, the distances between the adjacent concave-convex composite textures are gradually increased from inside to outside in a gradient pattern; a distance between every two of the adjacent concave-convex composite textures in the central region is S₁=50-280 μm; a distance between every two of the adjacent concave-convex composite textures in the intermediate region is S₂=280-480 μm; and a distance between every two of the adjacent concave-convex composite textures in the peripheral region is S₃=480-600 μm.

13. The microtextured proton exchange membrane for the fuel cell according to claim 12, wherein a radius of the first protrusion is r₁=10-300 μm and a height of the first protrusion is h₃=10-300 μm; a radius of the micro-pit is r₂=5-160 μm and a depth of the micro-pit is h₄=5-160 μm; a radius of the second micro-protrusion is r₃=5-160 μm and a height of the second micro-protrusion is h₅=5-160 μtm; and the concave-convex composite textures account for 35%-70% of a total surface area of the cathode surface.

14. A processing method of the microtextured proton exchange membrane for the fuel cell according to claim 2, comprising the following steps:
processing the cathode surface directly by laser, so that the cathode surface is partially gasified and a plurality of petal-shaped concave-convex composite textures are formed; and
deburring by ultrasonic cleaning or glow discharge cleaning or sputter cleaning.

15. The processing method of the microtextured proton exchange membrane for the fuel cell according to claim 14, wherein specific parameters of the laser processing comprise divergence angle being smaller than 0.5 mrad, output beam quality being M≤1.3, spot diameter being not greater than 3 mm, wavelength being 1064 nm, power being 1-25 W, single pulse energy being 1-100 p, pulse width being 1-100 ps, and repetition frequency being 1-10 MHz.

16. A processing method of the microtextured proton exchange membrane for the fuel cell according to claim 2, comprising the following steps:
obtaining a first stamping die with the pits and the protrusions by plasma etching or ultrafast laser processing, and deburring the first stamping die by ultrasonic cleaning and glow discharge cleaning;
processing the pits and the protrusions on the cathode surface by using the first stamping die;
obtaining a second stamping die with the hemi-ellipsoidal micro-pits by plasma etching or ultrafast laser processing, and deburring the second stamping die by ultrasonic cleaning and glow discharge cleaning; and
processing the hemi-ellipsoidal micro-pits on the cathode surface by using the second stamping die.
